(19) United States
(12) Patent Application Publication
(10) Pub. No.: US 2026/0039944 A1
(43) Pub. Date: Feb. 5, 2026

(54) ELECTRONIC APPARATUS, METHOD OF CONTROLLING THE SAME, AND STORAGE MEDIUM

(71) Applicant: CANON KABUSHIKI KAISHA, Tokyo (JP)

(72) Inventor: KOSUKE KIKUI, Kanagawa (JP)

(21) Appl. No.: 19/275,678

(22) Filed: Jul. 21, 2025

(30) Foreign Application Priority Data
Jul. 31, 2024 (JP) 2024-125234

(51) Int. Cl. H04N 23/62; H04N 23/63

(52) U.S. Cl. CPC H04N 23/62; H04N 23/631

(57) ABSTRACT

An electronic apparatus includes an operation unit for receiving a specific touch operation, a first pressing operation, and a second pressing operation following the first, an assignment unit for assigning a function to each pressing operation based on a user-selected setting, and a control unit for performing processing corresponding to a specific function in response to the specific touch operation, and processing corresponding to each function assigned to the first and second pressing operations in response to the first and second pressing operations, respectively, wherein the control unit switches between performing and not performing the processing corresponding to the specific function in response to the specific touch operation based on the functions assigned to the first and second pressing operations, and based on whether an operation received by the operation unit is the first pressing operation or the second pressing operation.

### BACKGROUND

### Field of the Technology

The present disclosure relates to an electronic apparatus, a method of controlling the electronic apparatus, and a storage medium.

### Description of the Related Art

There have been known digital cameras including an operation unit to which a user can assign a desired function. For example, a function (e.g., autofocus) selected by the user is assigned to a predetermined operation unit, and the assigned function is performed by the user operating the predetermined operation unit.

Among operation units included in imaging apparatuses, some can receive two operations, i.e., a first-stage pressing operation and a second-stage pressing operation, on a single operation unit. Japanese Patent Application Laid-Open No. 2001-346080 discusses a digital camera including a shutter release button that can receive the first-stage pressing operation and the second-stage pressing operation. In response to the first-stage pressing operation performed on the shutter release button, a moving image is recorded in a recording medium, and in response to a second-stage pressing operation, a still image is recorded in the recording medium.

Further, some operation units can receive two kinds of operations, i.e., a pressing operation (a press) and a touch operation (a touch-move), on the operation surface of a single operation unit. Japanese Patent Application Laid-Open No. 2020-181450 discusses that a ranging point is moved in response to a touch-move on an AF-ON button, and autofocusing is performed at a current ranging point in response to a press of the AF-ON button.

### SUMMARY

The present disclosure is directed to providing an electronic apparatus having improved usability with an operation unit that can receive a specific touch operation, a first pressing operation, and a second pressing operation following the first pressing operation on the same operation surface of the operation unit.

According to an aspect of the present disclosure, an electronic apparatus includes an operation unit having an operation surface, the operation unit configured to receive on the operation surface a specific touch operation, a first pressing operation, and a second pressing operation following the first pressing operation; at least one memory storing a program; and at least one processor that, upon execution of the stored program, is configured to function as: an assignment unit configured to assign a function to each of the first pressing operation and the second pressing operation based on a setting selected by a user, and a control unit configured to perform processing corresponding to a specific function in response to the operation unit receiving the specific touch operation, processing corresponding to the function assigned to the first pressing operation in response to the operation unit receiving the first pressing operation, and processing corresponding to the function assigned to the second pressing operation in response to the operation unit receiving the second pressing operation, wherein the control unit switches between performing and not performing the processing corresponding to the specific function in response to the operation unit receiving the specific touch operation based on the functions assigned to the first pressing operation and the second pressing operation, and based on whether an operation received by the operation unit is the first pressing operation or the second pressing operation.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a configuration of an imaging apparatus according to a first exemplary embodiment.

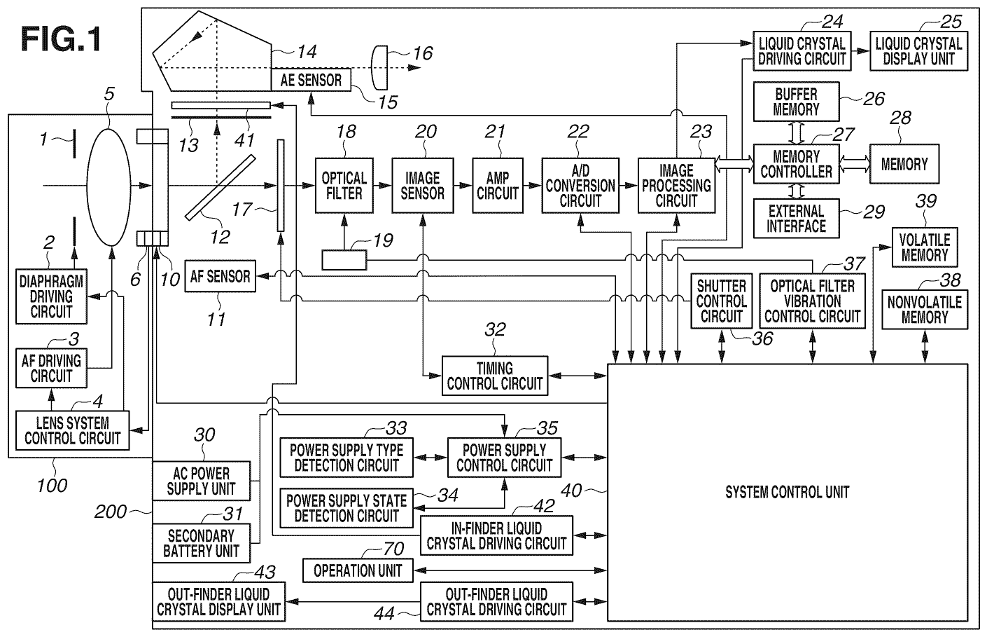

FIG. 2A is an appearance diagram illustrating the front of the imaging apparatus according to the first exemplary embodiment. FIG. 2B is an appearance diagram illustrating the rear of the imaging apparatus according to the first exemplary embodiment.

FIG. 2C is a configuration diagram illustrating an AF-ON button according to the first exemplary embodiment that can receive a plurality of operations.

FIG. 3A illustrates an example of a setting screen for assigning functions to the AF-ON button according to the first exemplary embodiment. FIG. 3B illustrates an example of combinations of functions assigned to the AF-ON button according to the first exemplary embodiment.

FIGS. 4A and 4B illustrate a flowchart of processing relating to the AF-ON button according to the first exemplary embodiment.

FIG. 5 illustrates an example of a setting screen relating to a touch-move operation on the AF-ON button according to the first exemplary embodiment.

### DESCRIPTION OF THE EMBODIMENTS

Some exemplary embodiments of the present disclosure will now be described in detail with reference to the accompanying drawings. In the present specification and the drawings, components having substantially the same functional configuration may be denoted by the same reference numerals, and redundant descriptions will therefore be omitted. In the exemplary embodiments, an imaging apparatus 200 is described as an example of an electronic apparatus. However, the electronic apparatus is not limited thereto.

### [Configuration of Imaging Apparatus 200]

A first exemplary embodiment will be described. A lens unit 100 includes a replaceable lens 5. While the lens 5 normally includes a plurality of lenses, a single lens alone is illustrated for simplification.

A communication terminal 6 is a communication terminal via which the lens unit 100 communicates with the imaging apparatus 200. A communication terminal 10 is a communication terminal via which the imaging apparatus 200 communicates with the lens unit 100.

The lens unit 100 communicates with a system control unit 40 via the communication terminals 6 and 10. A lens system control circuit 4 inside the lens unit 100 controls a diaphragm 1 via a diaphragm driving circuit 2 and changes a position of the lens 5 to perform focusing via an autofocus (AF) driving circuit 3. The system control unit 40 acquires a full aperture value and a minimum aperture value of the lens unit 100 via the communication terminals 6 and 10.

An auto-exposure (AE) sensor 15 measures luminance of an object through the lens unit 100.

An AF sensor 11 outputs information on an amount of defocus to the system control unit 40. The system control unit 40 controls the lens unit 100 based on the information on the amount of defocus.

A quick return mirror 12 is moved up and down by a not-illustrated actuator in response to an instruction from the system control unit 40 during exposure.

A user can check the focal point of an optical image of the object obtained through the lens unit 100 and a composition by looking at a focusing screen 13 through a pentaprism 14 and a viewfinder 16.

A focal-plane shutter 17 can freely control the exposure time of an image sensor 20 under the control of the system control unit 40.

An optical filter 18 generally includes a lowpass filter and cuts off high-frequency components of light that enter the opening of the focal-plane shutter 17 to guide an object image to the image sensor 20.

As the image sensor 20, a charge coupled device (CCD), a complementary metal-oxide semiconductor (CMOS), or the like is generally used. The image sensor 20 photoelectrically converts the object image formed on the image sensor 20 through the lens unit 100 to receive the object image as an electric signal.

An amplifier (AMP) circuit 21 amplifies the received electric signal with a gain corresponding to a set imaging sensitivity.

An analog-to-digital (A/D) conversion circuit 22 converts the electric signal from the image sensor 20, which is in the form of an analog signal, into a digital signal.

An image processing circuit 23 performs filter processing, color conversion processing, and gamma/knee processing on image data converted into the digital signal by the A/D conversion circuit 22 to output resultant image data to a memory controller 27. The image processing circuit 23 also includes a digital-to-analog (D/A) conversion circuit. The image processing circuit 23 can convert the image data converted into the digital signal by the A/D conversion circuit 22 and image data input from the memory controller 27 into analog signals to output the analog signals to a liquid crystal display unit 25 via a liquid crystal driving circuit 24. The image processing and the display processing performed by the image processing circuit 23 are switched by the system control unit 40. Further, the system control unit 40 performs white balance adjustment based on color balance information regarding the captured image.

The liquid crystal display unit 25 is a rear monitor for displaying an image. The liquid crystal display unit 25 is not limited to a liquid crystal display. Other displays, such as an organic electroluminescence (EL) display, can be used as long as they can display an image.

The memory controller 27 stores unprocessed image data input from the image processing circuit 23 in a buffer memory 26 and image data subjected to the image processing performed by the image processing circuit 23 in a recording medium (a memory) 28. Further, reversely, the memory controller 27 receives image data from the buffer memory 26 or the memory 28 to output the image data to the image processing circuit 23.

The memory controller 27 can store image data transmitted via an external interface 29 in the memory 28, and reversely, output image data stored in the memory 28 externally via the external interface 29. As the external interface 29, universal serial bus (USB), Institute of Electrical and Electronics Engineers (IEEE), and high-definition multimedia interface (HDMI®) interfaces can be used.

The memory 28 is a detachable recording medium, such as a memory card. However, the memory 28 can be a built-in memory. A focus position can be previously stored (registered) in the memory 28. The system control unit 40 controls the driving timing of the image sensor 20 via a timing control circuit 32.

A power supply control circuit 35 controls the power supplied from an alternating-current (AC) power supply unit 30 or a secondary battery unit 31. The power supply control circuit 35 turns the power supply on or off in response to an instruction from the system control unit 40. The power supply control circuit 35 notifies the system control unit 40 of information on a state of the current power supply detected by a power supply state detection circuit 34 and information on a type of the current power supply detected by a power supply type detection circuit 33.

The system control unit 40 controls the focal-plane shutter 17 via a shutter control circuit 36.

An optical filter vibration control circuit 37 vibrates a piezoelectric element 19 connected to the optical filter 18. The optical filter vibration control circuit 37 vibrates the piezoelectric element 19 with a predetermined vibration amplitude for a predetermined vibration time in a predetermined axial direction based on an instruction from the system control unit 40.

A nonvolatile memory 38 is a nonvolatile recording medium and can hold setting values desirably set by the user, for example, a shutter speed, an aperture value, and an imaging sensitivity, and other various kinds of data even in a state where the imaging apparatus 200 is turned off.

A volatile memory 39 can hold data desired to be temporarily stored, such as an internal state of the imaging apparatus 200 and information regarding the detachable memory 28.

An in-viewfinder liquid crystal display unit 41 displays a frame indicating a ranging point at which autofocusing is currently being performed, an icon indicating a setting state of the imaging apparatus 200, and the like, via an in-viewfinder liquid crystal driving circuit 42.

An external-viewfinder liquid crystal display unit 43 displays various setting values of the imaging apparatus 200, for example, a shutter speed and an aperture value, via an external-viewfinder liquid crystal driving circuit 44.

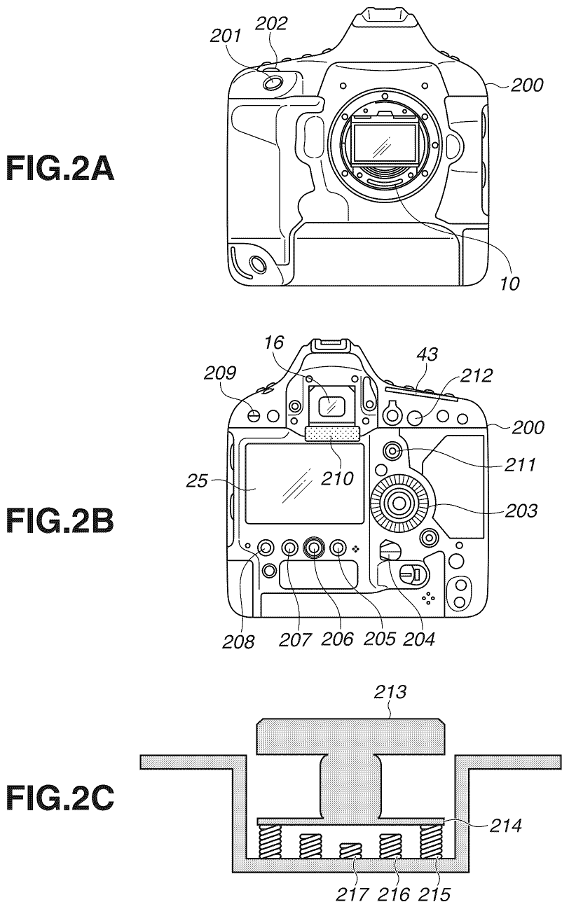

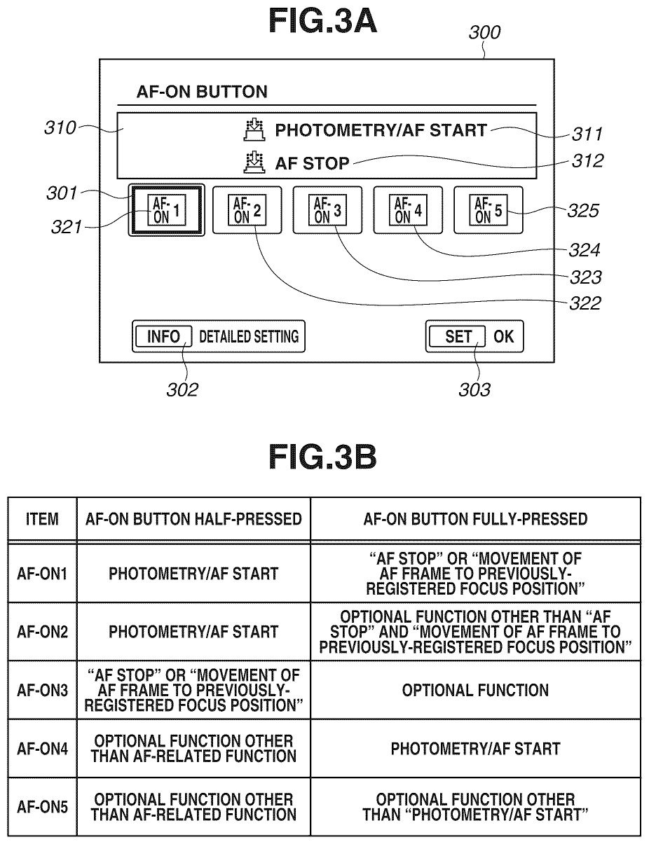

An operation unit 70 includes various kinds of operation members as an input unit that receives operations from a user. As illustrated in FIGS. 2A and 2B, the operation unit 70 includes a release button 201, a main electronic dial 202, a sub electronic dial 203, a power supply switch 204, and a protect button 205. As illustrated in FIGS. 2A and 2B, the operation unit 70 further includes a delete button 206, an enlargement mode button 207, a playback instruction button 208, a menu button 209, a viewfinder eye proximity detection unit 210, a multi-controller 211, and an AF-ON button 212.

The system control unit 40 controls each of the units included in the imaging apparatus 200. The system control unit 40 loads programs stored in the nonvolatile memory 38 using the volatile memory 39 as a working memory and executes the loaded programs to perform various kinds of processing described below.

The system control unit 40 can detect touch operations and pressing operations on the AF-ON button 212 based on notifications (output information) received from the AF-ON button 212. The system control unit 40 calculates a direction of movement (hereinafter, referred to as a “moving direction”) of a finger and the like on the AF-ON button 212 as one of eight directions (upper, lower, left, right, upper left, lower left, upper right, and lower right) based on the output information received from the AF-ON button 212. Further, the system control unit 40 calculates an amount of movement (hereinafter, referred to as an “amount of moving (x, y)”) of the finger and the like on the AF-ON button 212 in two-dimensional directions (x-axis and y-axis) based on the output information received from the AF-ON button 212.

The imaging apparatus 200 controls AF so that an AF target object is in focus in the captured image acquired by the image sensor 20. The system control unit 40 controls the image processing circuit 23 to combine and display a frame (hereinafter, referred to as an “AF frame”) indicating a position of the AF target object in the captured image with the captured image. As described below, the system control unit 40 performs control to change a display position of the AF frame in response to an operation on the AF-ON button 212. Further, the system control unit 40 controls AF to bring the AF target object into focus at a position corresponding to the AF frame.

The system control unit 40 can detect the following operations on or states of the AF-ON button 212: an operation in which a finger or the like that is not in touch with the AF-ON button 212 is newly touching the AF-ON button 212, i.e., the start of a touch (hereinafter, referred to as a “touch-down”); a state where a finger or the like is in touch with the AF-ON button 212 (hereinafter, referred to as a “touch-on”); an operation in which a finger or the like is moving while keeping in touch with the AF-ON button 212 (hereinafter, referred to as a “touch-move”); an operation in which a finger that has been in touch with the AF-ON button 212 is released from the AF-ON button 212, i.e., the end of a touch (hereinafter, referred to as a “touch-up”); and a state where nothing is in touch with the AF-ON button 212 (hereinafter, referred to as a “touch-off”).

As a touch-down is detected, a touch-on is also detected at the same time. After the touch-down is detected, the touch-on is usually continuously detected until a touch-up is detected. A touch-move is detected in a state where a touch-on is detected. In a case where the amount of moving (x, y) is zero even when a touch-on is detected, a touch-move is not detected. After a touch-up of all touched fingers and the like is detected, a touch-off is detected.

The system control unit 40 determines which operation (touch operation) has been performed on the AF-ON button 212 based on an operation, a state, a moving direction, and the amount of moving (x, y). As for the touch-move, the direction of movement in the eight directions of upper, lower, left, right, upper left, lower left, upper right, and lower right, or the amount of movement in the two-dimensional directions of the x-axis and the y-axis, are detected as movements of the finger or the like on the AF-ON button 212. When a direction of movement in one of the eight directions or an amount of movement in one or both of the two-dimensional directions of the x-axis and the y-axis is detected, the system control unit 40 determines that a touch-move operation has been performed. In the present exemplary embodiment, the AF-ON button 212 includes an infrared sensor that can detect a touch operation by the user. However, the sensor included in the AF-ON button 212 can be a resistive film sensor, a surface acoustic wave sensor, an electrostatic capacitance sensor, an electromagnetic induction sensor, an image recognition sensor, an optical sensor, or the like.

### [Description of Appearance Diagram of Imaging Apparatus 200]

FIG. 2A is an appearance diagram illustrating the front of the imaging apparatus 200, and FIG. 2B is an appearance diagram illustrating the rear of the imaging apparatus 200.

The release button 201 is used to issue an imaging preparation instruction and an imaging instruction. In response to a half-press of the release button 201, measurement of luminance of the object and focusing are performed. In response to a full-press of the release button 201, the shutter is released and an image is captured.

The main electronic dial 202 is a rotary operation member. The user turns the main electronic dial 202 to set setting values of a shutter speed, an aperture value, and the like, and to perform fine adjustment of an enlargement magnification in an enlargement mode.

The sub-electronic dial 203 is a rotary operation member. The user turns the sub electronic dial 203 to set setting values of an aperture value, an exposure correction, and the like, and to perform an operation of displaying images one by one in an image display state.

The power supply switch 204 is an operation member used to turn the power supply on or off.

The protect button 205 is used to perform processing, such as protection and rating, on images stored in recording media inside and outside the imaging apparatus 200.

The delete button 206 is used to delete an image stored in recording media inside and outside the imaging apparatus 200.

The enlargement mode button 207 is used to receive operations to instruct a transition to the enlargement mode (i.e., an enlargement mode start instruction) and to instruct an exit from the enlargement mode (i.e., an enlargement mode end instruction) in a playback state.

The playback instruction button 208 is used to display, on the liquid crystal display unit 25, images stored in recording media inside and outside the imaging apparatus 200.

The menu button 209 is used to display various kinds of setting screens on the liquid crystal display unit 25.

The viewfinder eye proximity detection unit 210 is a sensor used to detect whether the user is looking into the viewfinder 16.

The multi-controller 211 is an operation member operable in a plurality of directions to set a ranging point as the start point of autofocusing and to move an enlargement frame (an enlarged range) in an enlarged image display state.

### [Configuration of AF-ON Button 212]

The AF-ON button 212 is an operation member used to instruct the start of autofocusing on the object in an image. FIG. 2C is a configuration diagram illustrating the AF-ON button 212 that can receive a plurality of operations. The AF-ON button 212 enables a pressing operation in two stages and receives inputs corresponding to each respective stage. Hereinafter, as for the two-stage pressing operation on the AF-ON button 212, a first pressing operation stage is defined as a “half-press”, and a second pressing operation stage following the first pressing operation stage is defined as a “full-press.” Further, when a “touch-move operation” is performed as a touch operation on the AF-ON button 212, the touch-move operation is detected and processing corresponding to the touch-move operation is performed.

A key top 213 is configured to be exposed as a part of the AF-ON button 212 that the user first touches when pressing the AF-ON button 212. The surface of the key top 213 serves as a sensor that can receive the touch-move operation. The surface of the key top 213 is used as an “operation surface,” and the AF frame can be moved by the touch-move operation performed on the operation surface. Further, as described below, the operation surface of the key top 213 is a surface on which a finger of the user or the like is touched when the user half presses or fully presses the AF-ON button 212. As described above, implementation of the AF-ON button 212 as a single operation unit allows a touch-move, a half-press, and a full-press to be performed on the same operation surface of the key top 213.

A conductive member 214 is connected to the key top 213 and is configured to be lowered by force applied from above.

A ground spring 215 is connected to the conductive member 214 and is grounded.

A half-press detection spring 216 of the AF-ON button 212 is configured to come into contact with the conductive member 214 lowered by force applied from the operation surface of the key top 213. Since the conductive member 214 is connected to the grounded ground spring 215, a half-press is detected when the conductive member 214 and the half-press detection spring 216 of the AF-ON button 212 come into contact with each other.

A full-press detection spring 217 of the AF-ON button 212 is configured to come into contact with the conductive member 214 lowered by force applied from the operation surface of the key top 213. As with the half-press detection spring 216 of the AF-ON button 212, a full-press is detected when the conductive member 214 and the full-press detection spring 217 of the AF-ON button 212 come into contact with each other.

The full-press detection spring 217 of the AF-ON button 212 is configured to be lower in height than the half-press detection spring 216 of the AF-ON button 212. With such a configuration, when a full-press of the AF-ON button 212 is detected, a half-press of the AF-ON button 212 is also inevitably detected. In other words, when a half-press and a full-press are detected in order, a function assigned to the half-press and a function assigned to the full-press are started in that order. The function assigned to the half-press is continued while the function assigned to the full-press is being performed.

### [Functions Assigned to AF-ON Button 212]

In the present exemplary embodiment, functions other than a function of instructing a start of autofocusing can be assigned to the AF-ON button 212.

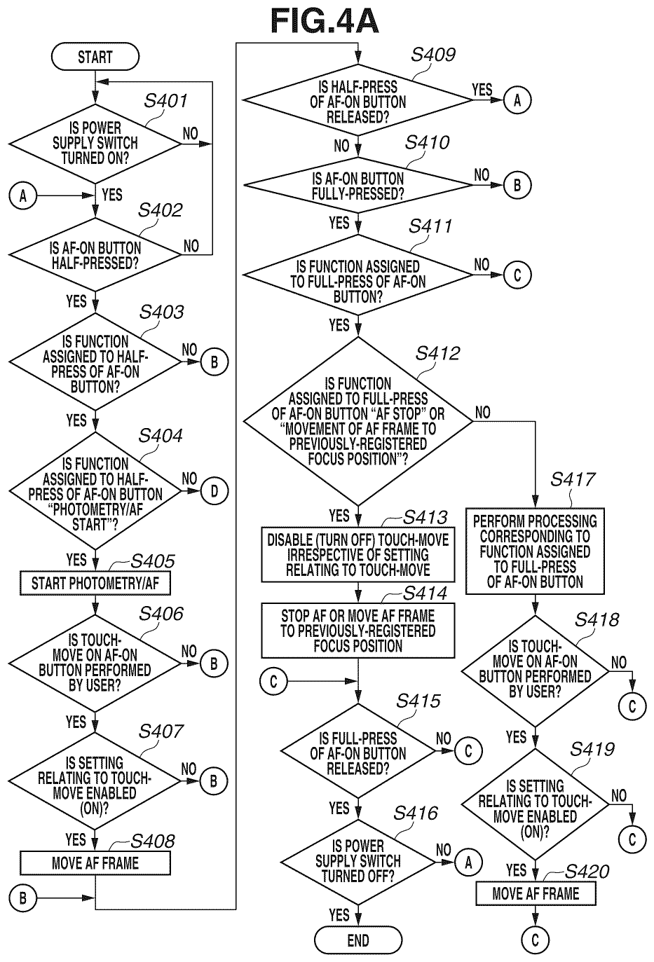

FIG. 3A illustrates a setting screen 300 used to assign functions to the half-press and the full-press of the AF-ON button 212. When a “button customize” item is selected in a menu screen, followed by selection of “AF-ON button 212”, the setting screen 300 is displayed. As combinations of functions settable to the half-press and the full-press of the AF-ON button 212, items 321 to 325 are displayed as options on the setting screen 300. Further, a cursor 301 indicating an item being selected, a setting content display area 310 of the item being selected, a detailed setting icon 302, and an OK icon 303 are displayed on the setting screen 300.

The user can operate an operation unit 70 to move the cursor 301 to one of the items 321 to 325 and change the item being selected. The items 321 to 325 respectively correspond to AF-ON1 to AF-ON5, which are combinations of the functions assigned to the half-press and the full-press of the AF-ON button 212. FIG. 3B illustrates the combinations AF-ON1 to AF-ON5 of the functions that can be assigned to the half-press and the full-press of the AF-ON button 212. Information on the combinations of the functions is stored in the nonvolatile memory 38. In this example, a function of “AF stop” is set as the full-press function for AF-ON1 and the half-press function for AF-ON3 as an initial setting. However, the function can be changed to a function of “movement of AF frame to a pre-registered focus position” by the user. An “optional function” set as the full-press function for AF-ON2, the full-press function for AF-ON3, the half-press function for AF-ON4, the half-press function for AF-ON5, and the full-press function for AF-ON5 can be selected by the user. When a function is selected or changed, the system control unit 40 updates the information on the combinations of the functions that can be assigned to the half-press and the full-press of the AF-ON button 212, which is stored in the nonvolatile memory 38. Further, the system control unit 40 reads the information on the combinations of the functions that can be assigned to the half-press and the full-press of the AF-ON button 212 stored in the nonvolatile memory 38 to identify the functions set for the respective items.

The setting content display area 310 displays, for the item being selected, a function 311 assigned to the half-press of the AF-ON button 212 and a function 312 assigned to the full-press of the AF-ON button 212. In a case where the functions assigned to the half-press or the full-press of the AF-ON button 212 cannot be changed by the user, the functions 311 or 312 can be displayed in a grayed-out manner for distinction.

FIG. 3B is a diagram illustrating combinations of the functions that can be assigned to the half-press and the full-press of the AF-ON button 212. In a case of AF-ON1 (i.e., the item 321), the function assigned to the half-press of the AF-ON button 212 is “photometry/AF start,” and the function assigned to the full-press of the AF-ON button 212 is “AF stop.” The function assigned to the full-press of the AF-ON button 212 can be changed to “movement of AF frame to a pre-registered focus position.”

In a case of AF-ON2 (i.e., the item 322), the function assigned to the half-press of the AF-ON button 212 is “photometry/AF start.” The function assigned to the full-press of the AF-ON button 212 is an optional function other than “AF stop” or “movement of AF frame to a pre-registered focus position.” The function assigned to the full-press of the AF-ON button 212 can be selected by the user.

Examples of the optional function other than “AF stop” or “movement of AF frame to pre-registered focus position” include displaying a setting screen, assisting settings, and relating to playback. Examples of the function of displaying a setting screen include displaying an imaging mode setting screen, a menu screen, a quick setting screen, a white balance setting screen, and other screens. Examples of the assisting settings function include illumination of the display panel, switching information displayed on the display panel, and the like. Examples of the function relating to playback include a play back of an image, an enlargement of the playback image, a deletion of the playback image, a rating of the playback image, and the like.

In a case of AF-ON3 (i.e., the item 323), the function assigned to the half-press of the AF-ON button 212 is “AF stop” or “movement of AF frame to a pre-registered focus position.” The function assigned to the full-press of the AF-ON button 212 is an optional function. The function assigned to the full-press of the AF-ON button 212 can be selected by the user. Examples of the optional function include “photometry/AF start,” displaying a setting screen, assisting settings, and relating to playback.

In a case of AF-ON4 (i.e., the item 324), the function assigned to the half-press of the AF-ON button 212 is an optional function other than an AF-related function. The function assigned to the full-press of the AF-ON button 212 is “photometry/AF start.” Examples of an AF-related function include “photometry/AF start,” “AF stop,” and “movement of AF frame to a pre-registered focus position.” Examples of the optional function other than an AF-related function include displaying a setting screen, assisting settings, and relating to playback.

In a case of AF-ON5 (i.e., the item 325), the function assigned to the half-press of the AF-ON button 212 is an optional function other than an AF-related function. The function assigned to the full-press of the AF-ON button 212 is an optional function other than “photometry/AF start.” Examples of the optional function other than an AF-related function include the displaying a setting screen, assisting settings, and relating to playback. Examples of the optional function other than “photometry/AF start” include “AF stop,” “movement of AF frame to a pre-registered focus position,” and optional functions other than an AF-related function.

In the present exemplary embodiment, it is assumed that the same function is not assigned to both the half-press and the full-press of the AF-ON button 212.

### [Processing of Disabling Function Performed by Touch-Move Based on Functions Assigned to AF-ON Button 212]

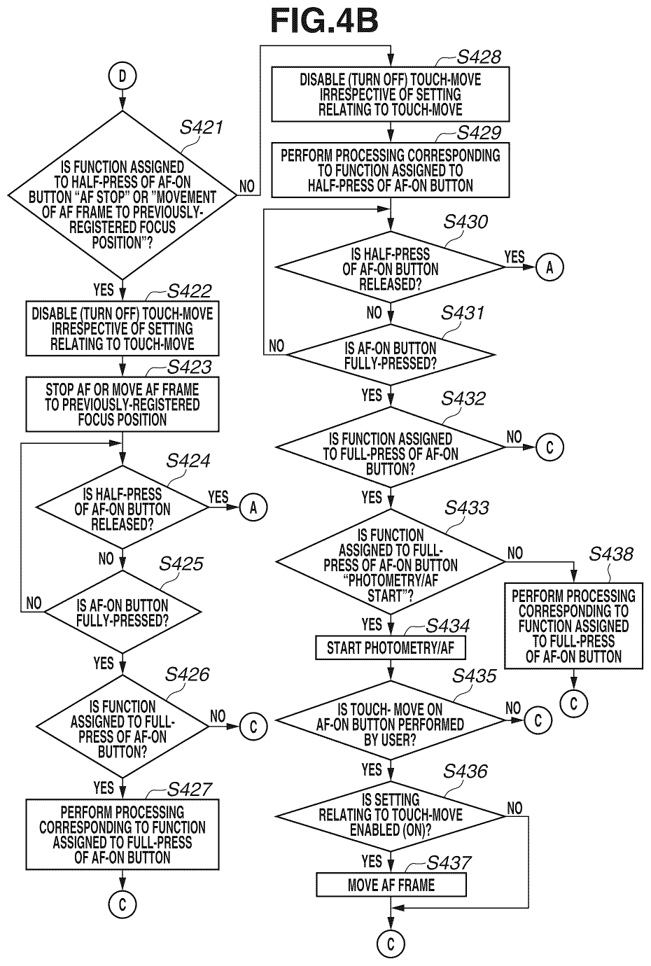

With reference to the flowchart in FIGS. 4A and 4B, processing will be described of disabling the function performed by a touch-move operation based on the functions assigned to the AF-ON button 212. In the present exemplary embodiment, the processing related to the AF-ON button 212 is performed while in the imaging mode of the imaging apparatus 200, in parallel with other processing, such as imaging processing, corresponding to an operation of the release button 201. The processing is performed by the system control unit 40 loading programs stored in the nonvolatile memory 38 to the volatile memory 39 and executing the programs.

In step S401, the system control unit 40 determines whether the power supply switch 204 is turned on. If the power supply switch 204 is turned on (YES in step S401), the processing proceeds to step S402. Otherwise (NO in step S401), the processing returns to step S401.

In step S402, the system control unit 40 determines whether the AF-ON button 212 is half-pressed by the user. If it is determined that the AF-ON button 212 is half-pressed (YES in step S402), the processing proceeds to step S403. Otherwise (NO in step S402), the processing returns to step S401.

In step S403, the system control unit 40 determines whether a function is assigned to the half-press of the AF-ON button 212. If it is determined that a function is assigned to the half-press of the AF-ON button 212 (YES in step S403), the processing proceeds to step S404. Otherwise (NO in step S403), the processing in step S404 is not performed, and the processing proceeds to step S409.

In step S404, the system control unit 40 determines whether the function assigned to the half-press of the AF-ON button 212 is “photometry/AF start.” If it is determined that the function assigned to the half-press of the AF-ON button 212 is “photometry/AF start” (YES in step S404), the processing proceeds to step S405. Otherwise (NO in step S404), the processing proceeds to step S421.

In step S405, the system control unit 40 starts photometry/AF processing. The processing then proceeds to step S406.

In step S406, the system control unit 40 determines whether the user has performed a touch-move operation on the AF-ON button 212. If it is determined that the user has performed a touch-move operation on the AF-ON button 212 (YES in step S406), the processing proceeds to step S407. Otherwise (NO in step S406), the processing in step S407 is not performed, and the processing proceeds to step S409.

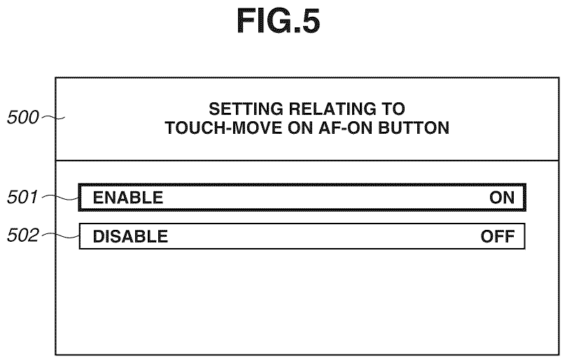

In step S407, the system control unit 40 determines whether a setting relating to the touch-move operation on the AF-ON button 212 (FIG. 5) is enabled (on). If the setting relating to the touch-move operation on the AF-ON button 212 is enabled (on) (YES in step S407), the processing proceeds to step S408. Otherwise (NO in step S407), the processing in step S408 is not performed, and the processing proceeds to step S409.

The user can configure a setting relating to the touch-move operation on the AF-ON button 212. In response to the user's selection of an item relating to the touch function in the menu screen of the imaging apparatus 200, a setting screen 500 illustrated in FIG. 5 is displayed on the liquid crystal display unit 25. The user can enable or disable the touch-move operation by selecting an enabled (on) setting 501 or a disabled (off) setting 502. If the setting relating to the touch-move operation is set to the enabled (on) setting 501, processing corresponding to the function assigned to the touch-move operation is performed. In contrast, if the setting relating to the touch-move operation is set to the disabled (off) setting 502, even when a touch-move operation is performed, the processing corresponding to the function assigned to the touch-move operation is not performed. In other words, if the touch-move operation is enabled, a movement of the AF frame by a touch-move operation on the AF-ON button 212 is performed, whereas if the touch-move operation is disabled, a movement of the AF frame by a touch-move operation on the AF-ON button 212 is not performed.

In step S408, the system control unit 40 moves the AF frame in response to a touch-move operation by the user. The processing then proceeds to step S409.

In step S409, the system control unit 40 determines whether the half-press of the AF-ON button 212 is released. If it is determined that the half-press of the AF-ON button 212 is released (YES in step S409), the processing returns to step S402. Otherwise (NO in step S409), the processing proceeds to step S410.

In step S410, the system control unit 40 determines whether the AF-ON button 212 is fully pressed. If it is determined that the AF-ON button 212 is fully pressed (YES in step S410), the processing proceeds to step S411. Otherwise (NO in step S410), the processing returns to step S409.

In step S411, the system control unit 40 determines whether a function is assigned to the full-press of the AF-ON button 212. If it is determined that a function is assigned to the full-press of the AF-ON button 212 (YES in step S411), the processing proceeds to step S412. Otherwise (NO in step S411), the processing in step S412 is not performed, and the processing proceeds to step S415.

In step S412, the system control unit 40 determines whether the function assigned to the full-press of the AF-ON button 212 is “AF stop” or “movement of AF frame to a pre-registered focus position.” If it is determined that the function assigned to the full-press of the AF-ON button 212 is “AF stop” or “movement of AF frame to a pre-registered focus position” (YES in step S412), the processing proceeds to step S413. Otherwise (NO in step S412), the processing proceeds to step S417.

In step S413, the system control unit 40 disables (turns off) the touch-move operation on the AF-ON button 212 irrespective of the setting relating to the touch-move operation on the AF-ON button 212. The processing then proceeds to step S414. In other words, even when the setting relating to the touch-move operation on the AF-ON button 212 is enabled, the processing corresponding to the function assigned to the touch-move operation on the AF-ON button 212 is not performed, and thus, a movement of the AF frame is not performed. With this configuration, when AF is stopped or the AF frame is moved to a pre-registered focus position by the user's full-press of the AF-ON button 212, a movement of the AF frame in response to an erroneous touch-move operation on the AF-ON button 212 performed by the user is not performed, and processing intended by the user can be performed.

In step S414, the system control unit 40 stops AF or moves the AF frame to a pre-registered focus position. The processing then proceeds to step S415.

In step S415, the system control unit 40 determines whether the full-press of the AF-ON button 212 is released. If it is determined that full-press of the AF-ON button 212 is released (YES in step S415), the processing proceeds to step S416. Otherwise (NO in step S415), the processing returns to step S415.

In step S416, the system control unit 40 determines whether the power supply switch 204 is turned off. If the power supply switch 204 is turned off (YES in step S416), the processing ends. Otherwise (NO in step S416), the processing returns to step S402.

As described above, when the item selected by the user as the function of the AF-ON button 212 is AF-ON1, the function assigned to the half-press of the AF-ON button 212 is “photometry/AF start” (YES in step S404). Thus, in the state where the AF-ON button 212 is half-pressed, a touch-move operation on the AF-ON button 212 switches between moving and not moving the AF frame based on the setting relating to the touch-move operation on the AF-ON button 212. Further, in the item AF-ON1, the function assigned to the full-press of the AF-ON button 212 is “AF stop” or “movement of AF frame to a pre-registered focus position” (YES in step S412). Thus, in the state where the AF-ON button 212 is fully pressed, a movement of the AF frame by a touch-move operation on the AF-ON button 212 is not performed irrespective of the setting relating to the touch-move operation on the AF-ON button 212.

In step S417, the system control unit 40 performs processing corresponding to the function assigned to the full-press of the AF-ON button 212. The processing then proceeds to step S418.

In step S418, the system control unit 40 determines whether the user has performed a touch-move operation on the AF-ON button 212. If it is determined that the user has performed a touch-move operation on the AF-ON button 212 (YES in step S418), the processing then proceeds to step S419. Otherwise (NO in step S418), the processing in step S419 is not performed, and the processing proceeds to step S415.

In step S419, the system control unit 40 determines whether the setting relating to the touch-move operation on the AF-ON button 212 is enabled (on). If the setting relating to the touch-move operation is enabled (on) (YES in step S419), the processing proceeds to step S420. Otherwise (NO in step S419), the processing in step S420 is not performed, and the processing proceeds to step S415.

In step S420, the system control unit 40 moves the AF frame in response to a touch-move operation on the AF-ON button 212. The processing then proceeds to step S415.

As described above, when the item selected by the user as the function of the AF-ON button 212 is AF-ON2, the function assigned to the half-press of the AF-ON button 212 is “photometry/AF start” (YES in step S404). Thus, in the state where the AF-ON button 212 is half pressed, a touch-move operation on the AF-ON button 212 switches between moving and not moving the AF frame based on the settings relating to the touch-move operation on the AF-ON button 212. Further, when the item selected by the user is AF-ON2, the function assigned to the full-press of the AF-ON button 212 is an optional function other than “AF stop” or “movement of AF frame to a pre-registered focus position” (NO in step S412). Thus, even in the state where the AF-ON button 212 is fully pressed, a touch-move switches between moving and not moving the AF frame based on the setting relating to the touch-move operation on the AF-ON button 212.

In step S421, the system control unit 40 determines whether the function assigned to the half-press of the AF-ON button 212 is “AF stop” or “movement of AF frame to a pre-registered focus position.” If it is determined that the function assigned to the half-press of the AF-ON button 212 is “AF stop” or “movement of AF frame to a pre-registered focus position” (YES in step S421), the processing proceeds to step S422. Otherwise (NO in step S421), the processing proceeds to step S428.

In step S422, the system control unit 40 disables (turns off) the touch-move operation on the AF-ON button 212 irrespective of the setting relating to the touch-move operation on the AF-ON button 212. The processing then proceeds to step S423. In other words, even when the setting relating to the touch-move operation on the AF-ON button 212 is enabled, the processing corresponding to the function assigned to the touch-move operation on the AF-ON button 212 is not performed, and a movement of the AF frame is not performed. With this configuration, when AF is stopped or the AF frame is moved to a pre-registered focus position by the user's half-press of the AF-ON button 212, a movement of the AF frame in response to an erroneous touch-move operation performed by the user is not performed, and processing intended by the user can be performed.

In step S423, the system control unit 40 stops AF or moves the AF frame to a pre-registered focus position. The processing then proceeds to step S424.

In step S424, the system control unit 40 determines whether the half-press of the AF-ON button 212 is released. If it is determined that the half-press of the AF-ON button 212 is released (YES in step S424), the processing proceeds to step S402. Otherwise (NO in step S424), the processing proceeds to step S425.

In step S425, the system control unit 40 determines whether the AF-ON button 212 is fully pressed. If it is determined that the AF-ON button 212 is fully pressed (YES in step S425), the processing proceeds to step S426. Otherwise (NO in step S425), the processing returns to step S424.

In step S426, the system control unit 40 determines whether a function is assigned to the full-press of the AF-ON button 212. If it is determined that a function is assigned to the full-press of the AF-ON button 212 (YES in step S426), the processing proceeds to step S427. Otherwise (NO in step S426), the processing in step S427 is not performed, and the processing proceeds to step S415.

In step S427, the system control unit 40 performs processing corresponding to the function assigned to full-press of the AF-ON button 212. The processing then proceeds to step S415.

As described above, when the item selected by the user is AF-ON3, the function assigned to half-press of the AF-ON button 212 is “AF stop” or “movement of AF frame to a pre-registered focus position” (YES in step S421). Thus, in the state where the AF-ON button 212 is half pressed, a movement of the AF frame by a touch-move operation on the AF-ON button 212 is not performed irrespective of the setting relating to the touch-move operation on the AF-ON button 212. Even though an optional function is assigned to the full-press of the AF-ON button 212 (YES in step S426), “AF stop” or “movement of AF frame to a pre-registered focus position” is assigned to the half-press of the AF-ON button 212. In other words, even when the AF-ON button 212 is fully pressed, the function assigned to the half-press of the AF-ON button 212, which is “AF stop” or “movement of AF frame to a pre-registered focus position,” continues to be performed. Thus, even when the AF-ON button 212 is fully pressed, a movement of the AF frame by a touch-move operation on the AF-ON button 212 is not performed irrespective of the setting relating to the touch-move operation on the AF-ON button 212.

In step S428, the system control unit 40 disables (turns off) the touch-move operation on the AF-ON button 212 irrespective of the setting relating to the touch-move operation on the AF-ON button 212. The processing then proceeds to step S429. In other words, even when the setting relating to the touch-move operation on the AF-ON button 212 is enabled, the processing corresponding to the function assigned to the touch-move operation on the AF-ON button 212 is not performed, and thus, a movement of the AF frame is not performed. With this configuration, a function other than an AF-related function is performed by the user half-pressing the AF-ON button 212, and a movement of the AF frame in response to an erroneous operation performed by the user can be prevented.

In step S429, the system control unit 40 performs processing corresponding to the function assigned to the half-press of the AF-ON button 212. The processing then proceeds to step S430.

In step S430, the system control unit 40 determines whether the half-press of the AF-ON button 212 is released. If it is determined that the half-press of the AF-ON button 212 is released (YES in step S430), the processing returns to step S402. Otherwise (NO in step S430), the processing proceeds to step S431.

In step S431, the system control unit 40 determines whether the AF-ON button 212 is fully pressed. If it is determined that the AF-ON button 212 is fully pressed (YES in step S431), the processing proceeds to step S432. Otherwise (NO in step S431), the processing returns to step S430.

In step S432, the system control unit 40 determines whether a function is assigned to the full-press of the AF-ON button 212. If it is determined that a function is assigned to the full-press of the AF-ON button 212 (YES in step S432), the processing proceeds to step S433. Otherwise (NO in step S432), the processing in step S433 is not performed, and the processing proceeds to step S415.

In step S433, the system control unit 40 determines whether the function assigned to the full-press of the AF-ON button 212 is “photometry/AF start.” If it is determined that the function assigned to the full-press of the AF-ON button 212 is “photometry/AF start” (YES in step S433), the processing proceeds to step S434. Otherwise (NO in step S433), the processing proceeds to step S438.

In step S434, the system control unit 40 starts photometry/AF processing. The processing then proceeds to step S435.

In step S435, the system control unit 40 determines whether the user has performed a touch-move operation on the AF-ON button 212. If it is determined that the user has performed a touch-move operation on the AF-ON button 212 (YES in step S435), the processing proceeds to step S436. Otherwise (NO in step S435), the processing in step S436 is not performed, and the processing proceeds to step S415.

In step S436, the system control unit 40 determines whether the setting relating to the touch-move operation on the AF-ON button 212 is enabled (on). If the setting relating to the touch-move operation on the AF-ON button 212 is enabled (on) (YES in step S436), the processing proceeds to step S437. Otherwise (NO in step S436), the processing in step S437 is not performed, and the processing proceeds to step S415.

In step S437, the system control unit 40 moves the AF frame in response to a touch-move operation on the AF-ON button 212. The processing then proceeds to step S415.

As described above, when the item selected by the user as the function of the AF-ON button 212 is AF-ON4, the function assigned to the half-press of the AF-ON button 212 is an optional function other than an AF-related function (NO in step S421). Thus, in the state where the AF-ON button 212 is half pressed, a movement of the AF frame by a touch-move operation on the AF-ON button 212 is not performed irrespective of the setting relating to the touch-move operation on the AF-ON button 212. Further, the function assigned to the full-press of the AF-ON button 212 is “photometry/AF start” (YES in step S433). Thus, in the state where the AF-ON button 212 is fully pressed, a touch-move operation on the AF-ON button 212 switches between moving and not moving the AF frame based on the setting relating to the touch-move operation on the AF-ON button 212.

In step S438, the system control unit 40 performs processing corresponding to the function assigned to the full-press of the AF-ON button 212. The processing then proceeds to step S415.

As described above, when the item selected by the user as the function of the AF-ON button 212 is AF-ON5, the function assigned to the half-press of the AF-ON button 212 is an optional function other than an AF-related function (NO in step S421). Thus, in the state where the AF-ON button 212 is half pressed, a movement of the AF frame by a touch-move operation on the AF-ON button 212 is not performed irrespective of the setting relating to the touch-move operation on the AF-ON button 212. Further, because an optional function other than “photometry/AF start” is assigned to the full-press of the AF-ON button 212, a movement of the AF frame by a touch-move operation on the AF-ON button 212 is not performed irrespective of the setting relating to the touch-move operation on the AF-ON button 212.

As described above, in the present exemplary embodiment, a touch-move operation while a pressing operation is being performed (i.e., in a pressed state) is disabled (off) or enabled based on the function assigned to the half-press or the full-press of the AF-ON button 212. Thus, the processing corresponding to the function assigned to the touch-move operation on the AF-ON button 212 in response to an unintended touch-move operation on the AF-ON button 212 can be prevented.

A second exemplary embodiment will now be described. In the present exemplary embodiment, an example will be described where a button other than the AF-ON button 212 in the operation unit 70 is pressed. Based on a function assigned to an operation of the button other than the AF-ON button 212, a function assigned to the half-press of the AF-ON button 212, and a function assigned to the full-press of the AF-ON button 212, the touch-move operation is disabled in the state where the AF-ON button 212 is pressed.

In a case where “AF stop” or “movement of AF frame to a pre-registered focus position” is assigned to a button other than the AF-ON button 212, for example, the release button 201, the following operation is performed. Irrespective of the functions assigned to the half-press of the AF-ON button 212 and the full-press of the AF-ON button 212, a touch-move operation is disabled in the state where the AF-ON button 212 is half-pressed or fully pressed. In other words, when the AF-ON button 212 is half-pressed or fully pressed, a movement of the AF frame performed by a touch-move operation on the AF-ON button 212 is not performed.

In a case where “photometry/AF start” is assigned to a button other than the AF-ON button 212, for example, the release button 201, the following operation is performed. In the state where “AF stop” or “movement of AF frame to a pre-registered focus position” is assigned to the half-press of the AF-ON button 212, a touch-move operation is disabled while the AF-ON button 212 is being half-pressed or being fully pressed. In other words, when the AF-ON button 212 is half-pressed or fully pressed, a movement of the AF frame performed by a touch-move operation on the AF-ON button 212 is not performed.

Further, in the case where “photometry/AF start” is assigned to a button other than the AF-ON button 212, for example, the release button 201, the following operation is performed. In the state where “AF stop” or “movement of AF frame to a pre-registered focus position” is assigned to the full-press of the AF-ON button 212, a touch-move operation is disabled while the AF-ON button 212 is being fully pressed. In other words, when the AF-ON button 212 is fully pressed, a movement of the AF frame performed by a touch-move operation on the AF-ON button 212 is not performed. On the other hand, even in the state where the function of “AF stop” or “movement of AF frame to a pre-registered focus position” is assigned to the full-press of the AF-ON button 212, an optional function other than the AF-related functions may be assigned to the half-press of the AF-ON button 212. In such a case, when the AF-ON button 212 is half-pressed, a touch-move operation on the AF-ON button 212 switches between moving and not moving the AF frame based on the setting relating to the touch-move operation on the AF-ON button 212.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-125234, filed Jul. 31, 2024, the entirety of which is incorporated herein by reference.

What is claimed is:

1. An electronic apparatus comprising:
an operation unit having an operation surface, the operation unit configured to receive on the operation surface a specific touch operation, a first pressing operation, and a second pressing operation following the first pressing operation;
at least one memory storing a program; and
at least one processor that, upon execution of the stored program, is configured to function as:
an assignment unit configured to assign a function to each of the first pressing operation and the second pressing operation based on a setting selected by a user; and
a control unit configured to perform processing corresponding to a specific function in response to the operation unit receiving the specific touch operation, processing corresponding to the function assigned to the first pressing operation in response to the operation unit receiving the first pressing operation, and processing corresponding to the function assigned to the second pressing operation in response to the operation unit receiving the second pressing operation,
wherein the control unit switches between performing and not performing the processing corresponding to the specific function in response to the operation unit receiving the specific touch operation based on the functions assigned to the first pressing operation and the second pressing operation, and based on whether an operation received by the operation unit is the first pressing operation or the second pressing operation.

2. The electronic apparatus according to claim 1, wherein the assignment unit is configured to assign any of a first kind of function, a second kind of function, or a third kind of function to each of the first pressing operation and the second pressing operation.

3. The electronic apparatus according to claim 2,
wherein, in a case where the first kind of function is assigned to the first pressing operation, the control unit performs the processing corresponding to the specific function in response to the operation unit receiving the specific touch operation while the operation unit is receiving the first pressing operation, and
wherein, in a case where the second kind of function or the third kind of function is assigned to the first pressing operation, the control unit does not perform the processing corresponding to the specific function in response to the operation unit receiving the specific touch operation while the operation unit is receiving the first pressing operation.

4. The electronic apparatus according to claim 3, wherein, in a case where the second kind of function is assigned to the first pressing operation, the control unit does not perform the processing corresponding to the specific function in response to the operation unit receiving the specific touch operation while the operation unit is receiving the second pressing operation irrespective of the function assigned to the second pressing operation.

5. The electronic apparatus according to claim 4,
wherein, in the case where the second kind of function is assigned to the first pressing operation, the control unit does not perform the processing corresponding to the specific function in response to the operation unit receiving the specific touch operation while the operation unit is receiving the second pressing operation irrespective of the function assigned to the second pressing operation, and
wherein, in a case where the third kind of function is assigned to the first pressing operation, the control unit switches between performing and not performing the processing corresponding to the specific function in response to the operation unit receiving the specific touch operation based on the function assigned to the second pressing operation while the operation unit is receiving the second pressing operation.

6. The electronic apparatus according to claim 2,
wherein, in a case where the first kind of function is assigned to the first pressing operation, the control unit performs the processing corresponding to the specific function in response to the operation unit receiving the specific touch operation while the operation unit is receiving the first pressing operation,
wherein, in a case where the second kind of function is assigned to the first pressing operation, the control unit does not perform the processing corresponding to the specific function in response to the operation unit receiving the specific touch operation while the operation unit is receiving the second pressing operation, and
wherein, in a case where a function other than the second kind of function is assigned to the first pressing operation, the control unit performs the processing corresponding to the specific function in response to the operation unit receiving the specific touch operation.

7. The electronic apparatus according to claim 2,
wherein, in a case where the third kind of function is assigned to the first pressing operation, the control unit switches between performing and not performing the processing corresponding to the specific function in response to the operation unit receiving the specific touch operation based on the function assigned to the second pressing operation while the operation unit is receiving the second pressing operation, and
wherein, in a case where the second kind of function is assigned to the first pressing operation, the control unit does not perform the processing corresponding to the specific function in response to the operation unit receiving the specific touch operation while the operation unit is receiving the second pressing operation irrespective of the function assigned to the second pressing operation.

8. The electronic apparatus according to claim 7,
wherein, in a case where the third kind of function is assigned to the first pressing operation and the first kind of function is assigned to the second pressing operation, the control unit performs the processing corresponding to the specific function in response to the operation unit receiving the specific touch operation while the operation unit is receiving the second pressing operation,
wherein, in a case where the third kind of function is assigned to the first pressing operation and a function other than the first kind of function is assigned to the second pressing operation, the control unit does not perform the processing corresponding to the specific function in response to the operation unit receiving the specific touch operation while the operation unit is receiving the second pressing operation, and
wherein, in the case where the second kind of function is assigned to the first pressing operation, the control unit does not perform the processing corresponding to the specific function in response to the operation unit receiving the specific touch operation while the operation unit is receiving the second pressing operation irrespective of the function assigned to the second pressing operation.

9. The electronic apparatus according to claim 2,
wherein, in a case where the second kind of function is assigned to the first pressing operation, the control unit does not perform the processing corresponding to the specific function in response to the operation unit receiving the specific touch operation while the operation unit is receiving either the first pressing operation or the second pressing operation, and
wherein, in a case where the third kind of function is assigned to the first pressing operation, the control unit does not perform the processing corresponding to the specific function in response to the operation unit receiving the specific touch operation while the operation unit is receiving the first pressing operation, and switches between performing and not performing the processing corresponding to the specific function in response to the operation unit receiving the specific touch operation based on the function assigned to the second pressing operation while the operation unit is receiving the second pressing operation.

10. The electronic apparatus according to claim 2,
wherein the specific function is a function of moving an area relating to predetermined processing,
wherein the first kind of function and the second kind of function are functions relating to the predetermined processing, and
wherein the second kind of function is a function relating to a movement of the area or a function of stopping execution of the predetermined processing.

11. The electronic apparatus according to claim 10, wherein the first kind of function is a function of starting execution of the predetermined processing.

12. The electronic apparatus according to claim 2,
wherein the electronic apparatus is an imaging apparatus including an imaging unit,
wherein the specific function is a function of moving an autofocus (AF) frame,
wherein the first kind of function and the second kind of function are functions relating to AF,
wherein the first kind of function is a function of starting execution of AF, and
wherein the second kind of function is a function relating to a movement of the AF frame or a function of stopping execution of AF.

13. The electronic apparatus according to claim 1, wherein the at least one processor, upon execution of the stored program, is further configured to function as: a detection unit configured to detect a touch operation on the operation surface of the operation unit receiving the first pressing operation or the second pressing operation,
wherein the specific touch operation is a touch-move operation.

14. The electronic apparatus according to claim 2, wherein the at least one processor, upon execution of the stored program, is further configured to function as: a setting unit configured to perform a setting operation relating to whether to perform the processing corresponding to the specific function in response to the operation unit receiving the specific touch operation.

15. The electronic apparatus according to claim 14, wherein, in a case where the control unit does not perform the processing corresponding to the specific function based on the functions assigned to the first pressing operation and the second pressing operation, and based on whether an operation received by the operation unit is the first pressing operation or the second pressing operation, the control unit does not perform the processing corresponding to the specific function irrespective of the setting operation performed by the setting unit even in a case where the operation unit is receiving the touch operation.

16. The electronic apparatus according to claim 1, wherein the first pressing operation is a half-press operation and the second pressing operation is a full-press operation.

17. A method of controlling an electronic apparatus, the electronic apparatus including an operation unit having an operation surface, the operation unit configured to receive on the operation surface a specific touch operation, a first pressing operation, and a second pressing operation following the first pressing operation, the method comprising the steps of:
assigning a function to each of the first pressing operation and the second pressing operation based on a setting selected by a user; and
performing control to perform processing corresponding to a specific function in response to the operation unit receiving the specific touch operation, processing corresponding to the function assigned to the first pressing operation in response to the operation unit receiving the first pressing operation, and processing corresponding to the function assigned to the second pressing operation in response to the operation unit receiving the second pressing operation,
wherein the control is performed to switch between performing and not performing the processing corresponding to the specific function in response to the operation unit receiving the specific touch operation based on the functions assigned to the first pressing operation and the second pressing operation, and based on whether an operation received by the operation unit is the first pressing operation or the second pressing operation.

18. A non-transitory computer-readable storage medium that stores a program for causing a computer to perform the method of controlling the electronic apparatus according to claim 17.
